(19) United States
(12) Patent Application Publication
(10) Pub. No.: US 2010/0034939 A1
(43) Pub. Date: Feb. 11, 2010

(54) OVENABLE FILM

(76) Inventor: Dimitris Gkinosatis, Koropi Attica (GR)

Correspondence Address: JENKINS, WILSON, TAYLOR & HUNT, P. A., Suite 1200 UNIVERSITY TOWER, 3100 TOWER BLVD.,, DURHAM, NC, 27707, US

(21) Appl. No.: 12/512,361

(22) Filed: Jul. 30, 2009

(30) Foreign Application Priority Data
Aug. 11, 2008 (EP) 08 162 162.5

(51) Int. Cl. B65D 81/34; B32B 27/34; A23L 1/01

(52) U.S. Cl. 426/412; 428/476.3; 428/475.8; 428/35.2

(57) ABSTRACT

The present invention is directed to a plastic film suitable for an oven cooking process, comprising a multilayer film comprising having an outer layer comprising polyamide, where the polyamide has a melting point of at least 210° C., a core layer of crosslinked EVA copolymer and a sealing layer of polyester elastomer with melting point of less than 225° C.

### CROSS-REFERENCE TO RELATED APPLICATION

This application claims the benefit of European patent application No. 08 162 162.5, filed Aug. 11, 2008, the entire disclosure of which is herein incorporated by reference.

The present invention is directed to a plastic film suitable for an oven cooking process.

There is today a requirement for ovenable films. Ovenable films are films used for cooking food inside in real oven conditions.

The basic requirements for an ovenable film are:
1. To be able to withstand conditions of cooking in the oven eg for exposure to 190° C. for at least two hours.
2. To have a barrier to oxygen, so that the food may be packed in the film for prolonged amount of time with no subsequent spoilage.
3. To be able to heat seal, so that it can be converted to bags. Use of nags is more practical and preferred by the end users.
4. To have high abuse resistance for protection of the food of outside punctures and abuse. This is also needed in cases where vacuum packs are formed so that the packaging film must be strong enough to withstand the punctures from the sharp edges of the product.
5. To have acceptable optics so that the final pack can be attractive to consumer.
6. To have high resistance at 0° C., so that the food packs are suitable to be kept in refrigerated conditions.

Very well known films for this kind of applications include monolayer PET films and monolayer PA66 films. These films have very high resistance to heat and therefore are suitable for oven cooking, but they are very difficult to heat seal. So they are not suitable for convenient use for making bags.

Typical food which can be oven cooked are different soups, macaroni, chicken breasts, meat pieces and other food.

### SUMMARY OF THE INVENTION

It is, therefore, an object of the present invention to provide a multilayer film achieving the above properties.

The film has at least three layers, where
1. The outer layer comprises a polyamide with a melting point at least 210° C.
2. The core layer comprises an ethylene vinyl acetate copolymer (EVA) which has undergone crosslinking.
3. The inner sealing layer comprises a polyester elastomer with a melting point less than 225° C.

### DESCRIPTION OF PREFERRED EMBODIMENTS

The multilayer film has preferably at least 3 layers, more preferably at least 5 layers. The multilayer film is preferably produced with hot blown film method. Other production methods like biaxial orientation (double bubble or tenter frame) are also possible.

Preferably the film structure is of the configuration:

Outer layer/tie layer/core layer/tie layer/inner layer

Where the outer layer is the layer directly exposed to the outdoor environment and the inner layer is the layer at the inside of the tube.
1. Outer Layer
The outer layer of the film comprises a polyamide with a melting point at least 210° C.
Well known polyamides include polymers like PA6, PA66, PA6/66, PA610, PAMXD and others, or mixtures thereof. The outer layer material is also the material with the higher barrier to oxygen.
2. Core Layer
The core layer preferably comprises EVA copolymer with VA content from 5 to 40%, where 14 to 25% VA content is preferred.
This EVA copolymer must be crosslinked. The preferred way to achieve this is to irradiate the whole structure with beta or gamma radiation.
3. Inner Sealing Layer
The inner sealing layer preferably comprises a polyester elastomer with a melting point less than 225° C.
Polyester ether and polyester ester block copolymers are preferred. The hard blocks of these materials comprise PBT and the soft blocks comprise ether or ester units.
4. Tie layers
Between the core layer and the outer/inner layer, tie layers may be used to increase the adhesion. Suitable tie layers preferably are EVA maleic anhydrite modified copolymers. The VA content should be from 5 to 40 percent.

The total thickness of the film preferably is in the range of 30 to 400 microns, more preferably 50 to 200 microns. Preferable thickness for each inner and outer layer are 10 to 150 microns, more preferably 10 to 100 microns.

In the inner and outer layers some of the well known additives in the art may be used.

Such additives are slip, antiblock, antifog, flame retardant, antioxidants, fragrance, odour removal, anticorrosive. Inorganic fillers such as calcium carbonate, talc, mica, wollastonite, glass fibers and others well known in the art may be added.

Slip agents could be oleamide, erucamide and other amides known in the art. As antiblock agents natural and synthetic silica are preferred.

### Preferred Physical Properties of the Film

The film has an oxygen barrier of less than 100 cc/m²*DAY*ATM in 23° C. and 75% relative humidity, measured according to ASTM F 1927. In a more preferable case the oxygen transmission is less than 50 cc/m²*atm*day at 23° C., 75% RH, measured with ASTM F 1927.

The film is irradiated by e-beam or gamma radiation from 0.5 to 20 MRADS. Irradiation is increasing the strength of some materials by crosslinking, as is well known in the art.

### DEFINITIONS

The definitions used in the following are as follows:

The term “film” refers to a flat or tubular flexible structure of thermoplastic material.

All measurement methods mentioned herein are readily available for the skilled person. For example, they can be obtained from the American National Standards Institute at: www.webstore.ansi.org

The phrase “longitudinal direction” or “machine direction” herein abbreviated “MD” refers to a direction along the length of the film.

The phrase “outer layer” refers to the film layer which comes in immediate contact with the outside environment (atmosphere).

The phrase “inner layer” refers to the film layer that comes in direct contact with the product packed. This is also called “sealing layer” as this layer must be hermetically sealed in order to protect the product from ingress of air.

As used herein, the term “homopolymer” refers to a polymer resulting from polymerization of a single monomer.

As used herein, the term “copolymer” refers to a polymer resulting from polymerization of at least two different polymers.

As used herein, the term “polymer” includes both above types.

As used herein the term “polyethylene” identifies polymers consisting essentially of the ethylene repeating unit. The ones that have a density more than 0.940 g/cm³ are called high density polyethylene (HDPE), the ones that are have less than 0.940 g/cm³ are low density polyethylene (LDPE).

As used herein the phrase “ethylene alpha olefin copolymer” refers to polymers like linear low density polyethylene (LLDPE), medium density polyethylene (MDPE), very low density polyethylene (VLDPE), ultra low density polyethylene (ULDPE), metallocene catalysed polymers and polyethylene plastomers and elastomers.

As used herein the phrase “styrene polymers” refers to styrene homopolymer such as polystyrene and to styrene copolymers such as styrene-butadiene copolymers, styrene-butadiene-styrene copolymers, styrene-isoprene-styrene copolymers, styrene-ethylene-butadiene-styrene copolymers, ethylene-styrene copolymers and the like.

As used herein, the term “ethylene ester copolymers” refers to copolymers of ethylene and esters. This term includes materials like ethylene vinyl acetate copolymers, ethylene methacrylate copolymers, ethylene butyl acrylate copolymers and other polymers.

As used herein the phrase “ethylene methacrylate copolymers” refers to copolymers of ethylene and methacrylate monomer. The monomer content is preferably less than 40%.

As used herein the phrase “ethylene vinyl acetate copolymer” refers to copolymers of ethylene and vinyl acetate.

As used herein, the term EVOH refers to saponified products of ethylene vinyl ester copolymers. The ethylene content is typically in the range of 25 to 50%.

As used herein the term PVDC refers to a vinylidene chloride copolymer wherein a major amount of the copolymer comprises vinylidene chloride and a minor amount of the copolymer comprises one or more monomers such as vinyl chloride and/or alkyl acrylates and methacrylates.

As used herein the term polyamide refers to homopolymers and copolymers. Typical examples are polyamide 6, polyamide 66, polyamide 6/66, polyamide 12, polyamide 11, polyamide 6/12, polyamide 6/66/12, polyamide 6I/6T and others.

As used herein the term “polypropylene” refers to any homopolymer, copolymer, terpolymer, tetrapolymer etc. that includes mer units of propylene. The term as used in the present application includes homopolymers, random copolymers, propylene alpha olefin copolymers, propylene ethylene copolymers propylene-ethylene-alpha olefin copolymers and other propylene polymers.

### EXAMPLE 1

A 5 layer film is produced in multilayer hot blown film line, with the following structure.

| | |
|---|---|
| Inner layer | PEE1, thickness 15 microns |
| Tie layer | T1, thickness 5 microns |
| Barrier layer | EV1, thickness 30 microns |
| Adjacent layer | T1, thickness 5 microns |
| Outer layer | PA1, thickness 20 microns |

See Table 1

### COMPARATIVE EXAMPLE

A commercial material was used for comparison reasons. The material is a monolayer polyamide.

TABLE 1

| | | | Melt | | Melting |
|---|---|---|---|---|---|
| | | | Index | Density | point |
| Type | Description | Manufacturer | g/10 min | g/cm³ | ° C. |
| PEE1 | POLYESTER | DSM | | | 213 |
| | ELASTOMER | | | | |
| T1 | TIE LAYER | DUPONT | 2.5 | 0.950 | |
| PA1 | POLYAMIDE 6 | DSM | | | 220 |
| EV1 | EVA18% | DUPONT | 0.5 | 0.94 | |

The film was irradiated by e-beam process to a dose of 10 MRAD.

### Tests

Two tests were executed.

1. Oven Behaviour Testing.

The test was executed as follows:

Chicken pieces were vacuum packed in the material. Then, a small hole was made using a fork and the pack was inserted in an oven.

The oven temperature was 190° C. and it was kept at this temperature.

After 3 hours the packs were taken out of the oven and examined as per their appearance. Degradation and charring of the film were the main points to be noted.

The film of the invention had much less signs of thermal degradation (less charring) versus the commercial material. This is surprising because the inventive multilayer structure comprises materials with much lower melting points than the exposure temperature in an oven.

2. Bag Making

Both the inventive and the commercial film were checked for sealing properties on a Bosch sealing machine.

The commercial polyamide film was extremely difficult to heat seal. In the extreme conditions that this was possible, the seal was very brittle.

The inventive film was much easier to heat seal. The seals were much better.

What is claimed is:

1. A multilayer film comprising
an outer layer comprising a polyamide, where the polyamide has a melting point of at least 210° C.;
a core layer of crosslinked EVA copolymer; and
a sealing layer of polyester elastomer with a melting point of less than 225° C.

2. The film of claim 1, where the polyamide layer contains or consists of PA6, PA66, PA6/66, PA610, PAMXD or mixtures thereof.

3. The film of claim 1, where the EVA is crosslinked with ionizing radiation.

4. The film of claim 1, where the polyester elastomer is an ester-ether block copolymer.

5. The film of claim 1, where the film structure is of the configuration outer layer/tie layer/core layer/tie layer/inner layer.

6. The film of claim 5, where the core layer comprises EVA copolymer with VA content from 5 to 40%.

7. The film of claim 5, where the core layer comprises EVA copolymer with VA content from 14 to 25% VA content.

8. The film of claim 1, where the sealing layer comprises polyester ether and polyester ester block copolymers.

9. A bag made from the film of claim 1.

10. A cooking process where a piece of food is cooked in a film of claim 1.
